(19) United States
(12) Patent Application Publication
(10) Pub. No.: US 2005/0224444 A1
(43) Pub. Date: Oct. 13, 2005

(54) Milk bottle nipple structure

(75) Inventor: Takashi Akihiro, Kokubunji City (JP)

Correspondence Address: TROXELL LAW OFFICE PLLC, Suite 1404, 5205 Leesburg Pike, Falls Church, VA, 22041, US

(73) Assignee: Shu-Chen TSAI

(21) Appl. No.: 10/935,272

(22) Filed: Sep. 8, 2004

(30) Foreign Application Priority Data
Apr. 7, 2004 (JP) 2004-113299

(51) Int. Cl. A61J 9/00

(52) U.S. Cl. 215/11.1

(57) ABSTRACT

A milk bottle nipple is mainly to train the muscles of facial expression, including orbicularis oris muscle, for infants during milk feeding. Inside the nipple body, there is flexible cup-shaped interior structure. There are a multiple number of slits on the flange of the base side for the interior structure. The link between the nipple head and nipple body has a gradient. Thus, when the infant closes lips, the lips catch the gradient and press the nipple. Besides, the interior structure is under pressure to open up the slits, so the drink inside the bottle will flow through the slits toward the nipple head.

### FIELD OF THE INVENTION

The invention is related to a milk bottle nipple structure, especially a device to train the muscles of facial expression for infants.

### BACKGROUND OF THE INVENTION

There has not been a proper device to help mouth exercise for patient that has partial paralysis due to stroke or brain infraction. During the process to develop mouth rehabilitation device, the inventor found the disease-preventive effect for exercising orbicularis oris muscle and further noticed the necessity to train the muscles of facial expression for infants. Knowing the effects of exercising orbicularis oris muscle in prevention and curing for dementia, prevention and improvement for mouth breathing, snoring, obstructive sleep apnea syndrome, prevention for tooth decay and periodontal disease, prevention for allergy and infection. It is better to start training orbicularis oris muscle in infancy stage. However, a common milk bottle nipple cannot simulate breast-feeding in an exact way and fails to effectively exercise the muscles of facial expression. Therefore, the inventor proposed the design for a milk bottle nipple to train the orbicularis oris muscle for infants.

Thus, the objective of the invention is to provide a design for milk bottle nipple to train the muscles of facial expression, including orbicularis oris muscle, for infants.

### SUMMARY OF THE INVENTION

The solution is: the milk bottle nipple made of flexible material in the present invention is composed of a nipple head with an outlet allowing the bottle content to flow out, a nipple body linked to the nipple head of the hollow nipple, a cup-shaped interior structure made of flexible material inside the nipple body to control the flow of bottle content. As the features of the design, the nipple has a structure that facilitates the deformation of nipple body when lips are closed. Besides, the cup-shaped interior structure deforms to facilitate the flow of bottle content under squeezing pressure.

The structure of the nipple in the present invention to promote deformation is, for example, a gradient in the link between the nipple head and the nipple body, so the lips can hold it securely. Besides, the deformation promoting structure can be achieved by enhancing the toughness for the link of the nipple body and deformability for the nipple body. In fact, the former is achieved through increasing the thickness of the link, while the latter is achieved by decreasing the thickness of the nipple body. On the other hand, the deformability for the nipple body can also be improved by adding grooves to the peripheral of the nipple body. Other methods include concave for the base of the interior structure and several slits on the base peripheral from inside to outside of the interior structure.

### BRIEF DESCRIPTION OF DRAWINGS

FIG. 1 is the cross-section view for a nipple on a bottle cap for the first embodiment of the invention.

FIG. 2 is the top view for a milk bottle nipple for the first embodiment of the invention.

FIG. 3 is the cross-section view for a milk bottle nipple for the first embodiment of the invention.

FIG. 4 is the bottom view for a milk bottle nipple for the first embodiment of the invention.

FIG. 5 is the top view for an interior structure for one embodiment of the invention.

FIG. 6 is the three-dimensional view for an interior structure for one embodiment of the invention.

FIG. 7 is the status for infant mouth holding a nipple of the invention without closing lips.

FIG. 8 is the status for infant mouth holding and sucking a nipple of the invention with lips closed.

FIG. 9 is the cross-section view for a milk bottle nipple for the second embodiment of the invention.

FIG. 10 is the cross-section view for a milk bottle nipple for the third embodiment of the invention.

### DETAILED DESCRIPTION OF THE INVENTION

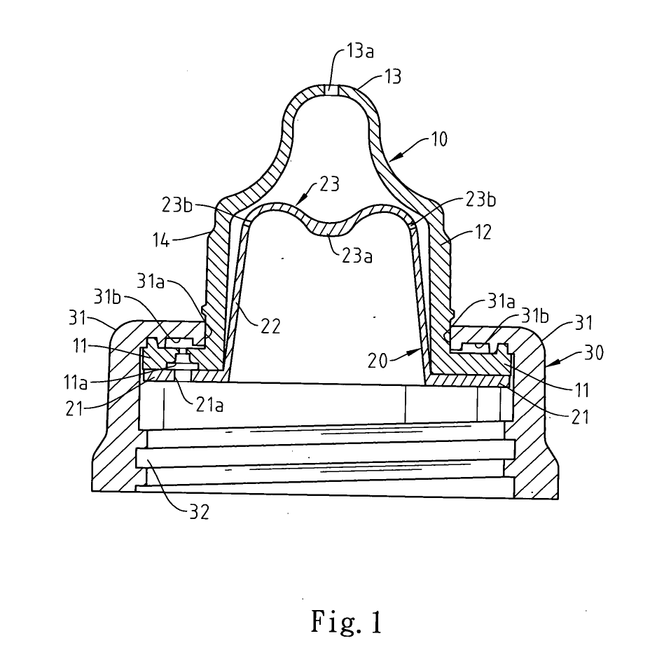

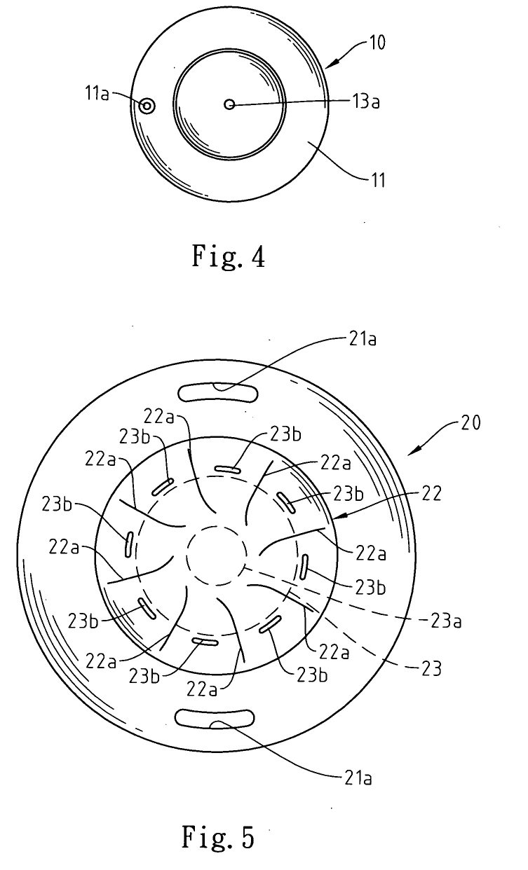

Please refer to the figures from FIG. 1 to FIG. 8 for the embodiment of the invention. Here, we use the first embodiment of the present invention to explain the milk bottle nipple structure.

When an infant closes lips to press its mother's breast and suck out human milk, the sucking action has an effect in exercising the muscles of facial expression, including orbicularis oris muscle, and its growth. Recently, bottle-feeding becomes popular. An infant does not need to use orbicularis oris muscle to get milk out of a common milk bottle. So its orbicularis oris muscle does not get a chance to be trained. In view of the fact that nipple sucking during breast-feeding can train the muscles of facial expression, including orbicularis oris muscle, the inventor for the present invention has developed a design for a milk bottle nipple, so that it provides the same training effect as breast-feeding.

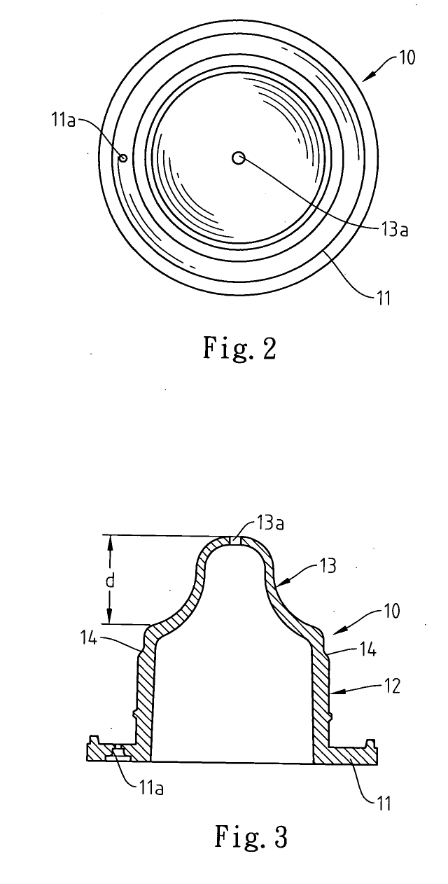

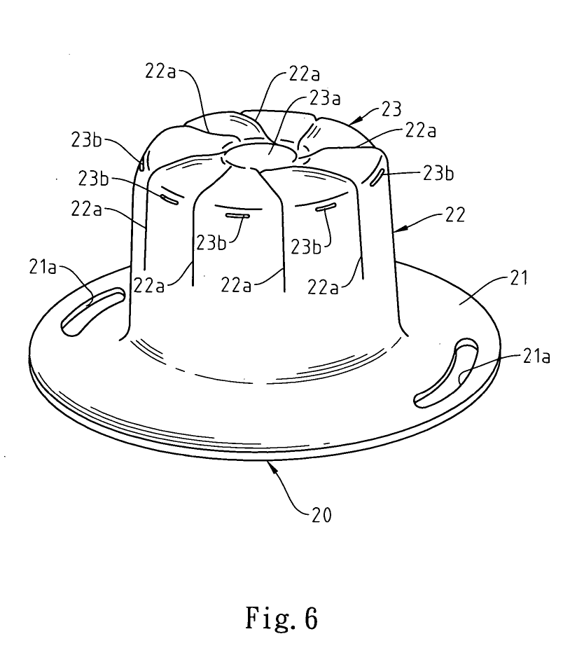

FIG. 1 is the cross-section view for a nipple on a bottle cap 30 for the first embodiment of the invention. In FIG. 2 to FIG. 4, the top view, cross-section view and the bottom view for a milk bottle nipple for the first embodiment of the invention are shown. In FIG. 5 and FIG. 6, the top view and the cross-section view for an interior structure for one embodiment of the invention are shown.

The embodiment is a sucking mechanism to simulate the shape for human nipple and breast with a milk bottle nipple 10 and a cup-shaped interior structure 20. The cup-shaped interior structure 20 is put inside the nipple 10, which is made of flexible materials like rubber, silicone, polyester elastomer and styrene elastomer etc. The nipple 10 is composed of a flange 11, a nipple body 12 and a nipple head 13. Besides, the interior structure 20 is also made of flexible materials like silicone, polyester elastomer and styrene elastomer etc. The interior structure 20 is composed of a flange 21 and a cup-shaped main body. It is placed inside the hollow portion of the nipple body 12.

The interior structure 20 can be installed into and removed from the nipple 10 freely. From a viewpoint of hygiene, with the design it is convenient to take out the interior structure 20 from the nipple 10 for cleaning purpose. From a viewpoint of economy, with the design it is also convenient to replace the broken interior structure or nipple.

At the center of the top of the nipple head 13, there is an outlet 13a for bottle content to flow out. Its shape may vary. The peripheral of the nipple body 12 is flange 11. As usually, the installation of the nipple 10 is to pass through the circular opening 31a centered on the top 31 of the cap 30. The size for the circular opening 31a is about the base of the nipple body 12, so that the flange 11 fits into the top 31 when the nipple 10 is put into the cap 30 and pressed to the end.

The cup-shaped body 22 for the interior structure 20 appears cup-like with its peripheral to match the flange 11 and the circular flange base 21 of the nipple 10. When the interior structure 20 is put into the nipple 10, the upward side of the flange base 21 (as in FIG. 1) matches the downward side of the flange 11.

When the thread 32 on the inner wall of the cap 30 is in lock with the milk bottle, the flange 11 and the flange base 21 will be clamped between the bottle opening and the inner base of the cap 30. Thus, the nipple 10 is locked firmly into the milk bottle. Besides, the flange 11 and the flange base 21 also provide leak-proof. On the inner base of the cap 30, there is a circular trench 31b, which corresponding position on the flange 11 of the nipple 10 there is a hole 11a. On the flange base 21 of the interior structure 20, there is an opening 21a corresponding to the hole 11a. Anyhow, the trench 31a, the hole 11a and the opening 21a are air releasing holes during sucking action to balance the pressure inside and outside the milk bottle.

The nipple head 13 refers to the sticking part extending from the large diameter portion of the top of the nipple body 12 (FIG. 1 and FIG. 3). It starts at a small slope upward and gradually has larger slope. When it reaches the top, the slope becomes small again and it forms a circular top. Besides, the link between the nipple head 13 and nipple body 12 has a gradient 14. Therefore, the nipple head 13 acts like mother's nipple, while the gradient 14 acts like the peripheral of mother's nipple. So infant lips can hold the gradient 14 securely and the infant can promote nipple 10 deformation by closing the lips to achieve the same sucking gesture as to breast-feeding.

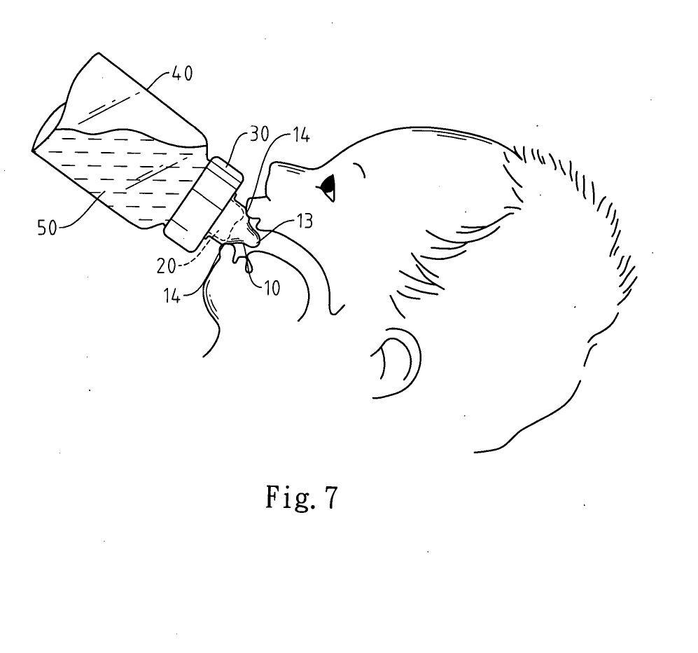

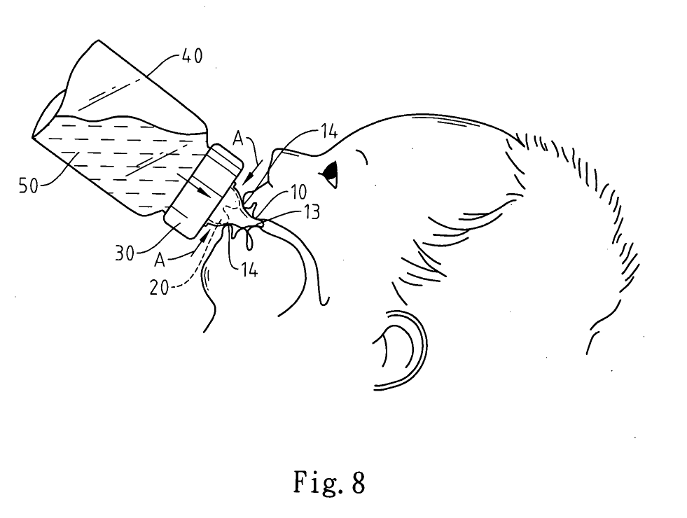

In one embodiment of the invention, the distance d from the bottom of the nipple head 13, ie. the top of nipple body 12 (for instance, the starting point of the curved part of the nipple 13 above the gradient 14), to the top of the nipple head 13 is within 15 mm, preferably between 11 mm and 12 mm. In this embodiment, it is 11.5 mm. A general milk bottle nipple has a similar shape to an extended human nipple in length above 2 cm. This embodiment is to simulate un-deformed nipple shape, which function and performance will be described later with reference to FIG. 7 and FIG. 8.

Please refer to FIG. 5 and FIG. 6 for detailed description for the interior structure for the first embodiment. The center of the base 23 for the cup-shaped body 22 is concave 23a, which is thicker and tougher than other portion of the cup-shaped body 22. On the exterior surface of the body 22, there are eight symmetric slightly helical slits 22a. Each slit 22a goes along the mother line from a certain height up to the base side 23 and shifts a little to the left until it reaches the peripheral of the concave 23a. They surround the exterior of the base side 23 for the concave 23a and appear protruding. The link between side top of the cup-shaped body 22 and the base side 23 is divided into eight sections by the slits 22a. Each section has a lateral slit 23b along the circular peripheral. Besides, on the peripheral of the flange base 21, there is an opening 21a of a certain length. As described earlier, the opening 21a is designed for the flange base 21 to prevent blockage of the hole 11 on the flange 11 of the nipple 10.

Please refer to FIG. 7 and FIG. 8 for the detailed description for the function and performance for the first embodiment of the invention. Both figures show the status for infant mouth holding a nipple to suck the drink from a milk bottle 40. FIG. 7 is the status for infant mouth holding a nipple of the invention without closing lips, i.e. lips exerting no pressure on the nipple. FIG. 8 is the status for infant mouth holding and sucking a nipple of the invention with lips closed, i.e. lips exerting pressure on the nipple body 12 toward A direction.

In FIG. 7, because lips are not closed yet, the nipple 10 is not deformed. Its interior structure 20 is not under external force either. At this moment, the lateral slits 23b on the side of the cup-shaped body 22 are closed to assure no flow out of the milk bottle.

In FIG. 8, because the lips are closed, the nipple body 12 is pressed on two sides (toward A direction). The lips on the gradient 14 of the nipple 10 can secure the link between the nipple body 12 and the nipple head 13. Thus, the infant can close lips to deform nipple body and feel the same as sucking human nipple.

With deformation of the nipple body, the front of the cup 22 is also deformed. Because the base side 23 is deformed too, the lateral slits 23b will open up. SO the drink 50 inside the milk bottle 40 can easily flow out through the slits 23b and the outlet 13a. Therefore, as long as the infant is sucking the nipple, the drink 50 inside the milk bottle 40 will be delivered to its mouth. Because the lateral slits 23b make the concave 23a tougher than the base side 23 and the cup surface has slits, the deformation around the lateral slits 23b will be maximized to facilitate opening when the nipple body 12 is under pressure.

When an infant is sucking human nipple, it uses tongue tip to move the nipple head upward. However, a general milk bottle nipple is longer than human nipple and its top reaches tongue tip, so it is very easy to move the nipple upward by tongue tip. It fails to provide a training effect for the tongue. In view of this, the embodiment of the invention reduces the length of the nipple head 13 and restricts the nipple to only touch the tongue tip. Thus, if the infant does not precisely use its tongue tip to move the nipple head 13 upward, it will not get the milk out. Such repeating action will help stimulate tongue muscle.

According to previous description, the nipple in the first embodiment can provide a real feeling for an infant to suck human nipple and facilitate the training of the muscles of facial expression, including orbicularis oris muscle. The nipple in this embodiment can provide a real feeling for an infant to use its tongue for sucking human nipple. In addition to exercise on the muscles of facial expression, it also provides exercise to tongue, enhancing the training effect. In summary, a common milk bottle nipple only allows milk to flow out, the nipple for the present invention also provides a chance for the infant to exercise its muscles of facial expression because it requires lips and tongue to get the milk out of the bottle.

The interior structure in the first embodiment does not intend to set any limitation. As long as it assures no flow under no pressure or flow under pressure, it falls in the scope of the invention.

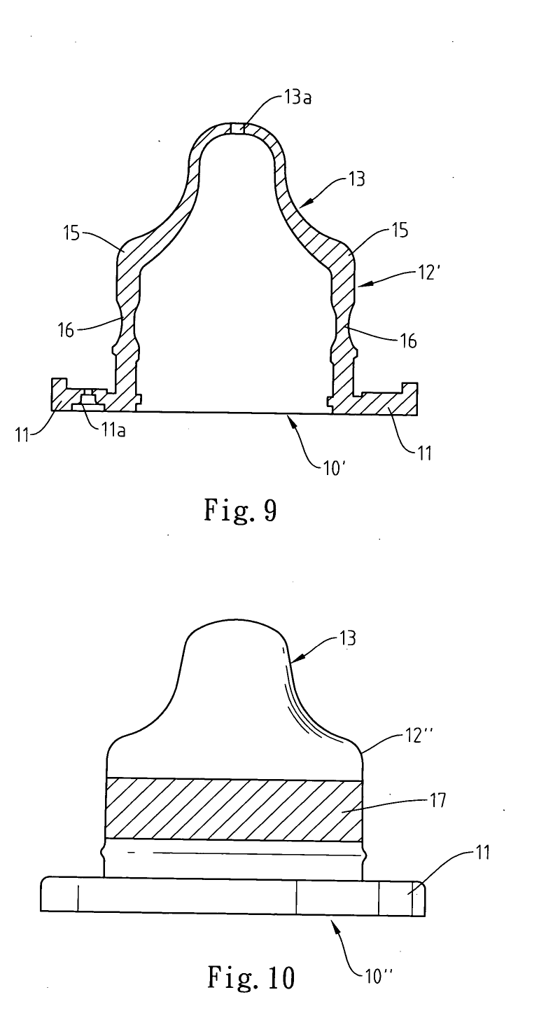

Please refer to FIG. 9 for the detailed description for the second embodiment. In the second embodiment, except for the nipple 10′ structure, others are generally identical to those in the first embodiment. The identical parts will be skipped in the following description.

FIG. 9 shows the cross-section view for the nipple 10′ for the second embodiment. It is composed of a flange 11′, a nipple body 12′ and a nipple head 13. The link 15 between the nipple head 13 and the nipple body 12′ is thicker than other portion. Besides, on the cross-section of the nipple body 12′, there is waist 16. The sidewall is thinner than its peripheral while other portion is identical to that in the first embodiment.

The second embodiment can provide the same effect as the first embodiment. For the nipple 10′ in the second embodiment, because the thickness of the link between the nipple head 12′ and the nipple body 13 is increased, its toughness is also increased. Also because the nipple body 13 is thinner, its deformability is increased. Thus, the lips can hold the link 15 equivalent to the peripheral of the real human nipple. Besides, the nipple body 13 is easier to deform, so it is easier for an infant to use lips to suck out milk.

Please refer to FIG. 10 for detailed description of the nipple for the third embodiment in the present invention. In the third embodiment, except for the nipple body 13, others are generally identical to those in the second embodiment. The identical parts will be skipped in the following description.

FIG. 10 shows the side view for the nipple 10′ for the third embodiment. It is composed of a flange 11, a nipple body 12″ and a nipple head 13. The trench 17 indicated by many inclined lines around the sidewall of the nipple body 12″ has many grooves inside, similar to the structure in the second embodiment.

The third embodiment has the same effect as the first embodiment. Similarly, the thickness of the link between the nipple head 13 and the nipple body 12″ in the third embodiment is increased as in the second embodiment to improve the toughness. It is equivalent to the peripheral of real human nipple, so lips will be easier to hold it. The deformability of the nipple body 12″ is also increased by the trench 17. Thus the link similar to the peripheral of a nipple is easier to hole by lips. The nipple head 12″ is also easier to deform. So it is easier for an infant to suck out milk with lips holding the nipple 10″.

The structure for either embodiment can be combined with each other freely.

1. A milk bottle nipple made of flexible material is composed of a nipple head with an outlet allowing the bottle content to flow out, a nipple body linked to the nipple head of the hollow nipple, a cup-shaped interior structure made of flexible material inside the nipple body to control the flow of bottle content; the nipple has a structure that facilitates the deformation of nipple body when lips are closed; besides, the cup-shaped interior structure deforms to facilitate the flow of bottle content under squeezing pressure.

2. As described in claim 1 for milk bottle nipple structure, the deformation promoting structure is a gradient at the link between the nipple head and the nipple body for the lips to hold securely.

3. As described in claim 1 for milk bottle nipple structure, the deformation promoting structure is made by increasing the toughness of the link between the nipple head and the nipple body and the deformability of the nipple body.

4. As described in claim 1 for milk bottle nipple structure, the center of the bottom of the cup-shaped interior structure has concave and many slits across the interior and the exterior of the bottom.

5. As described in claim 1 for milk bottle nipple structure, the toughness of the link is improved by increasing its thickness.

6. As described in claim 1 for milk bottle nipple structure, the deformability of the nipple body is improved by decreasing its thickness.

7. As described in claim 1 for milk bottle nipple structure, the slits on the peripheral of the nipple body are to improve the deformability of the nipple body.
